(19) United States
(12) Patent Application Publication
(10) Pub. No.: US 2010/0021375 A1
(43) Pub. Date: Jan. 28, 2010

(54) CATALYST FOR THE CHEMICAL DECOMPOSITION OF METALHYDRIDE

(76) Inventors: Alex Silberman, Haifa (IL); Shmuel Keren, Timrat (IL)

Correspondence Address: Pearl Cohen Zedek Latzer, LLP, 1500 Broadway, 12th Floor, New York, NY, 10036, US

(21) Appl. No.: 12/507,817

(22) Filed: Jul. 23, 2009

Related U.S. Application Data
(60) Provisional application No. 61/082,857, filed on Jul. 23, 2008.

(51) Int. Cl. C01B 3/04; B01J 31/02; B01J 31/06; B01J 29/04

(52) U.S. Cl. 423/648.1; 502/150; 502/172; 502/167; 502/159; 502/87

(57) ABSTRACT

The invention relates in general to the field of catalysts, in particular to a catalyst. More specifically, the invention relates to a catalyst for metal hydride chemical decomposition. In an embodiment of the invention, there is provided a catalyst for the chemical decomposition of metal hydrides, comprising a transition metal, or an alloy of several elements, wherein at least one of said elements is a transition metal; and an organic molecule.

### CROSS-REFERENCE TO RELATED APPLICATIONS

This application claims priority from U.S. Provisional Patent Application No. 61/082,857, filed Jul. 23, 2008 entitled “Catalyst for the chemical decomposition of metalhydride”, which is incorporated herein by reference in its entirety.

### FIELD OF THE INVENTION

The invention relates in general to the field of catalysts, in particular to a catalyst. More specifically, the invention relates to a catalyst for metal hydride chemical decomposition.

### BACKGROUND OF THE INVENTION

A catalyst in a chemical reaction is any component added to the reaction that increases the rate of the reaction, while remaining unchanged at the end of the reaction. Catalysts operate by providing an alternative reaction pathway to the reaction product, wherein the activation energy of the alternative pathway is lower than that of the reaction route that is not mediated by the catalyst.

Many chemical reactions, both in laboratories and in the industry, are carried out by using catalysts, and many catalysts are known in the art. For example, in the Haber process to manufacture ammonia, finely divided iron acts as a heterogeneous catalyst. Active sites on the metal allow partial weak bonding to the reactant gases, which are adsorbed onto the metal surface. As a result, the bond within the molecule of a reactant is weakened and the reactant molecules are held in close proximity to each other. In this way the particularly strong triple bond in nitrogen is weakened and the hydrogen and nitrogen molecules are brought closer together than would be the case in the gas phase, so the rate of reaction increases.

Also known in the art are metal-hydride solutions, such as NaBH₄ and KBH₄ solutions, from which hydrogen and energy are generated. Although such solutions tend to a certain amount of self-decomposing, the generation of hydrogen therefrom requires a catalyst. As known to those familiar with the art, an increase in the stability of such solutions drastically decreases the chemical decomposition rate, thus only by catalyst application can hydrogen and energy be generated therefrom. Several of the catalysts known in the art are ruthenium, rhodium, or platinum supported on various substrates. However, those metals are expensive materials, and therefore the price of device increased drastically.

### SUMMARY OF THE INVENTION

It is the object of the invention to provide a catalyst for the chemical decomposition of metal hydrides.

It is a further object of the invention to provide a catalyst that may be used to produce hydrogen from a metal-hydride solution.

It is yet another object of the invention to provide a method for producing hydrogen from a metal-hydride solution by contacting the solution with the catalyst of the invention.

The invention is directed to a catalyst for the chemical decomposition of metal hydrides, comprising a transition metal, or an alloy of several elements, wherein at least one of said elements is a transition metal; and an organic molecule.

The invention is further directed to a method of generating hydrogen from a metal hydride solution comprising the step of contacting the solution with a catalyst comprising a transition metal, or an alloy of several elements, wherein at least one of said elements is a transition metal; and an organic molecule.

All the above and other characteristics and advantages of the invention will be further understood through the following illustrative and non-limitative detailed description thereof.

### BRIEF DESCRIPTION OF THE DRAWINGS

The present invention will be understood and appreciated more fully from the detailed description taken in conjunction with the drawings in which:

FIG. 1 describes a system used for measuring the effectiveness of the catalyst of this invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

As mentioned above, the state of the art today is lacking in that the known catalysts are based on expensive materials. Thus, even though relatively small amounts of catalysts are needed in chemical reactions, the price of the catalyst becomes significant in the manufacture of devices, and regularly is the factor determining the price of the device in which the catalyst is used. Therefore, there is a long felt need for an efficient, yet inexpensive catalyst for the chemical decomposition of metal hydrides.

The catalyst according to the invention is a catalyst, for the chemical decomposition of metal hydrides, that is based on a transition metal, or an alloy of several elements, wherein at least one of the elements in the alloy is a transition metal; and at least one organic molecule.

In an embodiment of the invention, the organic molecule used in the catalyst of the invention can be, without limitation, any of the organic pigment catalysts disclosed in US Patent Application No. 2005/0158596 (US '596) that have an orbital structure identified by a low unoccupied molecular orbital (lumo) energy. More specifically, the organic pigment catalysts include, but are not limited to, pyranthrenedione, indanthrene gold orange, ditridecyl-3,4,9,10-perylenetetracarboxylic diimide, indanthrene black, dimethoxy violanthrone, 1,4-diketopyrrolo-3,4C pyrrole, quinacridone, indanthrene yellow, copper phthalocyanine, 3,4,9,10-peryle-netetracarboxylic dianhydride, isoviolanthrone, perylenetetracarboxylic diimide, and indigo. Cobalt phtalocyanine is also a possible organic pigment catalyst.

The organic compounds disclosed in US '596 are electrocalaysts, and therefore, the use of them alone as catalysts, requires an electrical supply. Accordingly, we note that the organic compounds disclosed in US '596 are used for direct borohydride oxidation, which occurs when a potential is applied between the anode and the cathode. Surprisingly, it was found that when the above organic compounds are used with at least one transition metal, or an alloy of several elements, wherein at least one of the elements in the alloy is a transition metal, a catalyst, which requires no electrical current for decomposing metal hydrides, is formed, and is therefore advantageous for many implementations. For example, the catalyst of the invention may be used in order to generate hydrogen from metal-hydride solutions by decomposing the metal hydride found in the solution. In addition, the invention includes a method of generating hydrogen from a metal-hydride containing solution. The metal hydride in the solution may be NaBH, KBH₄, LiBH₄, Be(BH₄)₂, Ca(BH₄)₂, Mg(BH₄)₂, (CH₃)₃NHBH₃, NaCNBH₃, LiH, NaH, KH, CaH₂, BeH₂, MgH₂, NaAlH, LiAlH₄, and KAlH₄, or any combination thereof. In one embodiment of the invention, the metal hydride may be NaBH₄ and/or KBH₄.

As mentioned above, the catalyst of the invention may include either one type of a transition metal, such as cobalt (Co), nickel (Ni), tin (Sn) or copper (Cu), or an alloy containing two or more elements, including at least one transition metal, which may be according to some embodiments of the invention Co, Ni, Sn, or Cu. Non-limiting examples of alloys that may be used according to the invention are Co—Ni—P, Co—P, Co—Ni—B, Co—B. In one embodiment of the invention, the transition metal used is Co. In another embodiment of the invention, the alloy comprises boron or phosphorous. According to the invention the alloys may be prepared by electroless, electro-deposition, or by any other appropriate method.

The catalysts according to the invention may be in solid form or in powder form, or in any other appropriate form known in the art.

In an embodiment of the invention the catalyst is deployed on a substrate. Non-limiting examples of such substrates that may be used according to the invention include ceramics, zeolites, non-woven polymers, glass, polymeric resins, cements, perovskites, plastics, fibers, fibrous materials, active carbon, acetylene or carbon black, graphite, including High Surface Area Graphite and Expanded Graphite or any mixtures thereof.

In another embodiment of the invention, binders may be mixed in with the catalysts of the invention. Non-limiting examples of such binders are polytetrafluoroethylene, perfluoroalkoxy, fluorinated ethylene propylene (i.e., Teflon®) and polyvinyldene fluoride.

As shown in the Examples below, the use of an organic molecule, such as 8,16-pyranthrenedione, as a catalyst, provides a relatively low hydrogen evolution rate (see Example 1, section A, in which the hydrogen evolution rate is 0.1 ml/(minutes×cm² of catalyst area)). Further, the use of an alloy containing, e.g., Co, Ni and phosphorous (P), also provides a relatively low hydrogen evolution rate (see Example 1, section B, in which the hydrogen evolution rate is 0.28 ml/(minutes×cm² of catalyst area)). When the Co—Ni—P alloy catalyst (comprising no organic molecule) is deployed on a porous support the hydrogen evolution rate increases (see Example 1, Section C, in which the hydrogen evolution rate is 4.0 ml/(minutes×cm² of catalyst area)). However, it was surprisingly found that once the Co—Ni—P alloy was deposited on a porous support on which an organic molecule, e.g., 8,16-pyranthrenedione, was already deposited, thereby forming the catalyst of this invention, the hydrogen evolution rate is further increased (see Example 1, Section D, in which the hydrogen evolution rate is 6.7 ml/(minutes×cm² of catalyst area)).

Moreover, when using a catalyst according to this invention, comprising a Co—P alloy and the organic molecule 8,16-pyranthrenedione on a porous support the hydrogen evolution is further increased (see Example 1, Section E, in which the hydrogen evolution rate is 10.2 ml/(minutes×cm² of catalyst area)).

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

The invention will be further illustrated with reference to the following illustrative examples, which are not intended to limit the scope of the invention in any manner.

### Examples

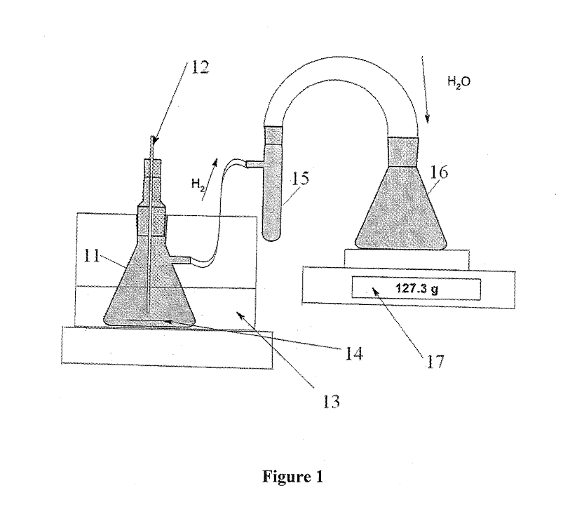

FIG. 1 describes a system assembled in order to measure the effectiveness of the catalyst of the invention, as detailed below. Solutions were placed in flask (11), where the temperature was continually measured by thermocouple (12). The temperature of the solutions was determined according to heater (13), and the solutions were continuously stirred by stirrer (14). When catalysts are added to the solution of flask (11), hydrogen is produced. When hydrogen is produced, it exits flask (11), through trap (15) to flask (16), which contains water. When the hydrogen enters flask (16), it replaces water found therein, thereby changing the weight of flask (16). The weight of flask (16) is constantly measured by scale (17), allowing the user to determine the weight of water displaced by the produced hydrogen thereby allowing the calculation of the amount of hydrogen produced, indicating the effectiveness of the catalyst of the invention.

A porous support was prepared as follows, and used in all of the Examples below:
1. 4.7 gr of active carbon, 3 gr of graphite powder and 0.8 gr of acetylene black were mixed;
2. 15 ml of Teflon® emulsion and 450 ml of DI water were added to the above mixture;
3. the mixture was heated to phase inversion, filtered and dried;
4. the obtained material was grinded; and
5. the obtained powder was pressed onto a Ni mesh surface.

### Example 1

A. Basic Organic Molecule Catalyst (with No Transition Metal) Preparation and Testing

0.5 gr of 8,16-pyranthrenedione was dissolved in 100 ml of hexane. A strip of copper foil was dipped into the solution, and then dried. This step was repeated three times. The obtained organic molecule catalyst, which was deposited on the copper foil, was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. The measured hydrogen evolution rate was 0.1 ml/(minutes×cm² of catalyst area).

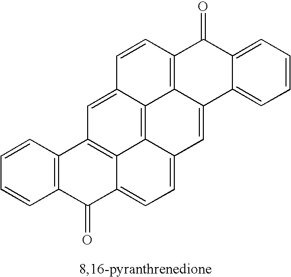

B. Co—Ni—P Alloy Catalyst (with No Organic Molecule) Preparation and Testing

A strip of copper foil, used as the anode, was placed into a flask containing 0.5 L of a solution, as described in Table II below. Co foil was added to the flask to be used as the cathode. The Co—Ni—P alloy was electrodeposited at 10 mA/cm² for 15 minutes. The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. The measured hydrogen evolution rate was 0.28 ml/(minutes×cm² of catalyst area).

TABLE II

| Material | Quantity (gr) |
|---|---|
| Cobalt chloride hexahydrate | 5.93 |
| Nickel chloride hexahydrate | 5.93 |
| Sodium hydroxide | 12.24 |
| Citric acid monohydrate | 21.43 |
| Boric acid | 15.0 |
| Sodium hypophosphite | 10.0 |
| Distilled water | 500 |

C. Co—Ni—P Alloy Catalyst (with No Organic Molecule) on Porous Support Preparation and Testing

A strip of the porous support prepared above, used as the anode, was placed into a flask containing 0.5 L of the solution detailed in Table II above. Co foil was added to the flask to be used as the cathode. The Co—Ni—P alloy was electrodeposited at 50 mA/cm² for 15 minutes. The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. The measured hydrogen evolution rate was 4.0 ml/(minutes×cm² of catalyst area).

D. Co—Ni—P Alloy and Basic Catalyst on Porous Support Preparation and Testing

0.5 gr of 8,16-pyranethrenedione were dissolved in 100 ml of hexane. A strip of the porous support prepared above was dipped into the 8,16-pyranethrenedione solution, and then dried. This step was repeated three times. The strip was then placed into a flask containing 0.5 L of the solution detailed in Table II above, to be used as the anode. Co foil was added to the flask to be used as the cathode. The Co—Ni—P alloy was electrodeposited at 10 mA/cm² for 15 minutes. The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. The measured hydrogen evolution rate was 6.7 ml/(minutes×cm² of catalyst area).

E. Optimized Co—P Alloy and Basic Catalyst on Porous Support Preparation and Testing

0.5 gr of 8,16-pyranethrenedione were dissolved in 100 ml of hexane. A strip of the porous support prepared above was dipped into the 8,16-pyranethrenedione solution, and then dried. This step was repeated three times. The strip was then placed into a flask containing 0.5 L of the solution detailed in Table III below, to be used as the anode. Co foil was added to the flask to be used as the cathode. The Co—P alloy was electrodeposited at 7.5 mA/cm² for 15 minutes. The current density was then increased to 0.6 A/cm² for two additional minutes. The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. The measured hydrogen evolution rate was 10.2 ml/(minutes×cm² of catalyst area).

TABLE III

| Material | Quantity (gr) |
|---|---|
| Cobalt chloride hexahydrate | 11.8 |
| Sodium hydroxide | 24 |
| Citric acid monohydrate | 42 |
| Ammonium sulfate | 65.9 |
| Sodium hypophosphite | 21.2 |
| Distilled water | 950 |

### Example 2

### No Transition Metal

0.5 gr of 8,16-pyranthrenedione were dissolved in 100 ml of hexane. A strip of the porous support was dipped into the 8,16-pyranthrenedione solution, and then dried.

The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination.

The measured hydrogen evolution rate was 0.9 ml/(minutes×cm² of catalyst area).

### Example 3

### Organic Catalyst+Transition Metal

0.5 gr of Cobalt phtalocyanine were dissolved in 100 ml of tetrahydrofuran. A strip of the porous support was dipped into the Cobalt phtalocyanine solution, and then dried.

The strip was then placed into a flask containing 0.5 L of the solution detailed in Table IV below, to be used as the anode. Co foil was added to the flask to be used as the cathode. The Co—P alloy was electrodeposited at 7.5 mA/cm² for 15 minutes. The current density was then increased to 0.6 A/cm² for two additional minutes. The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination.

The measured hydrogen evolution rate was 4.3 ml/(minutes×cm² of catalyst area).

TABLE IV

| Material | Quantity (gr) |
|---|---|
| Cobalt chloride hexahydrate | 11.8 |
| Sodium hydroxide | 24 |
| Citric acid monohydrate | 42 |
| Ammonium sulfate | 65.9 |
| Sodium hypophosphite | 21.2 |
| Distilled water | 950 |

### Example 4

### Organic Catalyst+Transition Metal

0.5 gr of indigo were dissolved in 100 ml of tetrahydrofuran. A strip of the porous support, prepared according to the description above, was dipped into the indigo solution, and then dried.

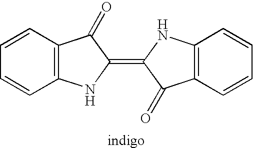

The strip was then placed into a flask containing 0.5 L of the solution detailed in Table IV above, to be used as the anode. Co foil was added to the flask to be used as the cathode. The Co—P alloy was electrodeposited at 7.5 mA/cm² for 15 minutes. The current density was then increased to 0.6 A/cm² for two additional minutes. The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. The measured hydrogen evolution rate was 3.9 ml/(minutes×cm² of catalyst area).

### Example 5

### No Transition Metal

0.5 gr of Cobalt phtalocyanine were dissolved in 100 ml of tetrahydrofuran. A strip of the porous support, prepared according to the description above, was dipped into the Cobalt phtalocyanine solution, and then dried.

The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination.

The measured hydrogen evolution rate was less than 0.1 ml/(minutes×cm² of catalyst area), and slight solution decomposition was detected.

### Example 6

### No Transition Metal

0.5 gr of indigo were dissolved in 100 ml of tetrahydrofuran. A strip of the porous support, prepared according to the above description, was dipped into the indigo solution, and then dried.

The obtained catalyst was placed in flask (11) of the system described in FIG. 1, at room temperature, wherein the solution in flask (11) comprised 4M NaBH₄, 1M KOH and 5 mM of 1,3-Bis(2,4,6-trimethylphenyl)imidazolinium chloride, for hydrogen evolution rate determination. No solution decomposition was detected and the hydrogen evolution rate was too small to be measured.

Although embodiments of the invention have been described by way of illustration, it will be understood that the invention may be carried out with many variations, modification, and adaptations, without departing from its spirit or exceeding the scope of the claims.

1. A catalyst for the chemical decomposition of metal hydrides, comprising a transition metal, or an alloy of several elements, wherein at least one of said elements is a transition metal; and an organic molecule.

2. The catalyst of claim 1, wherein the organic molecule is an organic pigment catalyst that has an orbital structure identified by a low unoccupied molecular orbital (lumo) energy.

3. The catalyst according to claim 2, wherein the organic pigment catalyst is pyranthrenedione, indanthrene gold orange, ditridecyl-3,4,9,10-perylenetetracarboxylic diimide, indanthrene black, dimethoxy violanthrone, 1,4-diketopyrrolo-3,4C pyrrole, quinacridone, indanthrene yellow, copper phthalocyanine, 3,4,9,10-peryle-netetracarboxylic dianhydride, isoviolanthrone, perylenetetracarboxylic diimide, indigo, cobalt phtalocyanine or any combination thereof.

4. The catalyst according to claim 1, wherein the alloy contains boron or phosphorus.

5. The catalyst according to claim 1, wherein the transition metal is Co.

6. The catalyst according to claim 1, wherein the alloy is Co—Ni—P, Co—P, Co—Ni—B, or Co—B.

7. The catalyst according to claim 1, wherein the alloy is Co—P.

8. The catalyst according to claim 1, wherein the organic molecule is 8,16-pyranthrenedione.

9. The catalyst according to claim 1, wherein the catalyst is in solid form or in powder form.

10. The catalyst according to claim 1, wherein the catalyst is deployed on a substrate.

11. The catalyst according to claim 10, wherein the substrate is prepared from ceramics, zeolites, non-woven polymers, glass, polymeric resins, cements, perovskites, plastics, fibers and fibrous materials, activated carbon, graphite, high surface area graphite, expanded graphite, acetylene black, carbon black, or any combination thereof.

12. The catalyst according to claim 1, further mixed with at least one binder.

13. The catalyst according to claim 12, wherein the binder is polytetrafluoroethylene, perfluoroalkoxy, fluorinated ethylene propylene, polyvinyldene fluoride, or any combination thereof.

14. A method of generating hydrogen from a metal hydride solution comprising the step of contacting the solution with a catalyst comprising a transition metal, or an alloy of several elements, wherein at least one of said elements is a transition metal; and an organic molecule.

15. The method according to claim 14, wherein the metal hydride is NaBH₄ or KBH₄.
